(19) United States
(12) Patent Application Publication
(10) Pub. No.: US 2025/0247516 A1
(43) Pub. Date: Jul. 31, 2025

(54) ELECTRONIC DEVICE AND INFORMATION DISPLAY SYSTEM

(71) Applicant: TOYOTA JIDOSHA KABUSHIKI KAISHA, Aichi-ken (JP)

(72) Inventor: Wataru KAKU, Musashino-shi (JP)

(21) Appl. No.: 19/026,362

(22) Filed: Jan. 17, 2025

(30) Foreign Application Priority Data
Jan. 29, 2024 (JP) 2024-011088

(51) Int. Cl. H04N 13/398; H04N 13/302; H04N 13/383

(52) U.S. Cl. CPC H04N 13/398; H04N 13/302; H04N 13/383

(57) ABSTRACT

An electronic device for displaying information includes a display having a display surface. A first user image represents a first user who is a user of a first electronic device communicating with the electronic device. A second user image represents a second user who is a user of a second electronic device communicating with the electronic device. The electronic device executes a 3D display process that displays the first user image and the second user image on the display such that the first user and the second user appear to float off the display surface. In a fixed mode in which the first user is set as a fixed user, the electronic device executes the 3D display process such that the first user appears to be closest to the display surface and the second user appears to be in front of the first user.

### CROSS-REFERENCES TO RELATED APPLICATION

The present disclosure claims priority to Japanese Patent Application No. 2024-011088, filed on Jan. 29, 2024, the contents of which application are incorporated herein by reference in their entirety.

### TECHNICAL FIELD

The present disclosure relates to an information display technique using an electronic device.

### BACKGROUND ART

Patent Literature 1 discloses a remote conference system. The remote conference system displays images of a plurality of users on a display screen. In addition, the remote conference system sets seat arrangement of the plurality of users in a virtual space based on attribute information such as the post of each user.

### LIST OF RELATED ART

Patent Literature 1: Japanese Laid-Open Patent Application No. JP-2022-054192

### SUMMARY

An object of the present disclosure is to provide a technique capable of reducing a sense of strangeness in appearance in 3D displaying of a plurality of users.

A first aspect is directed to an electronic device for displaying information.

The electronic device includes: a display having a display surface; and a controller.

A first user image is an image representing a first user who is a user of a first electronic device communicating with the electronic device.

A second user image is an image representing a second user who is a user of a second electronic device communicating with the electronic device.

The controller acquires the first user image and the second user image.

The controller executes a 3D display process that displays the first user image and the second user image on the display such that the first user and the second user appear to float off the display surface.

In a fixed mode in which the first user is set as a fixed user, the controller executes the 3D display process such that the first user appears to be closest to the display surface and the second user appears to be in front of the first user.

A second aspect is directed to an information display system.

The information display system includes a plurality of electronic devices connected to each other via a communication network.

Each of the plurality of electronic devices includes: a display having a display surface; and a controller.

A first user image is an image representing a first user who is a user of a first electronic device among the plurality of electronic devices.

A second user image is an image representing a second user who is a user of a second electronic device among the plurality of electronic devices.

The controller of a third electronic device among the plurality of electronic devices acquires the first user image and the second user image.

The controller of the third electronic device executes a 3D display process that displays the first user image and the second user image on the display such that the first user and the second user appear to float off the display surface.

In a fixed mode in which the first user is set as a fixed user, the controller of the third electronic device executes the 3D display process such that the first user appears to be closest to the display surface and the second user appears to be in front of the first user.

A third aspect is directed to an information display method in an electronic device including a display having a display surface.

A first user image is an image representing a first user who is a user of a first electronic device communicating with the electronic device.

A second user image is an image representing a second user who is a user of a second electronic device communicating with the electronic device.

The information display method includes:
acquiring the first user image and the second user image;
executing a 3D display process that displays the first user image and the second user image on the display such that the first user and the second user appear to float off the display surface; and
in a fixed mode in which the first user is set as a fixed user, executing the 3D display process such that the first user appears to be closest to the display surface and the second user appears to be in front of the first user.

A fourth aspect is directed to an information display program. The information display program causes the electronic device to execute the information display method according to the third aspect. The information display program may be recorded on a non-transitory computer-readable recording medium.

According to the present disclosure, in the fixed mode in which the first user is set as the fixed user, the 3D display process is executed such that the first user (i.e., the fixed user) appears to be closest to the display surface and the other second user appears to be in front of the first user. Since the positional relationship between the first user (i.e., the fixed user) and the other second user is expressed, the sense of strangeness in appearance in 3D displaying of the plurality of users is reduced.

### BRIEF DESCRIPTION OF DRAWINGS

FIG. 1 is a conceptual diagram for explaining an overview of an information display system;

FIG. 2 is a block diagram showing an example of a configuration of an electronic device;

FIG. 3 is a block diagram showing an example of a functional configuration of a controller of an electronic device;

FIG. 4 is a conceptual diagram showing a relative positional relationship between left and right eyes of a user and a display surface;

FIG. 5 is a conceptual diagram for explaining an example of a 3D display process in a fixed mode; and

FIG. 6 is a conceptual diagram for explaining another example of a 3D display process in a fixed mode.

### DETAILED DESCRIPTION

Embodiments of the present disclosure will be described with reference to the accompanying drawings.

### 1. Overview of Information Display System

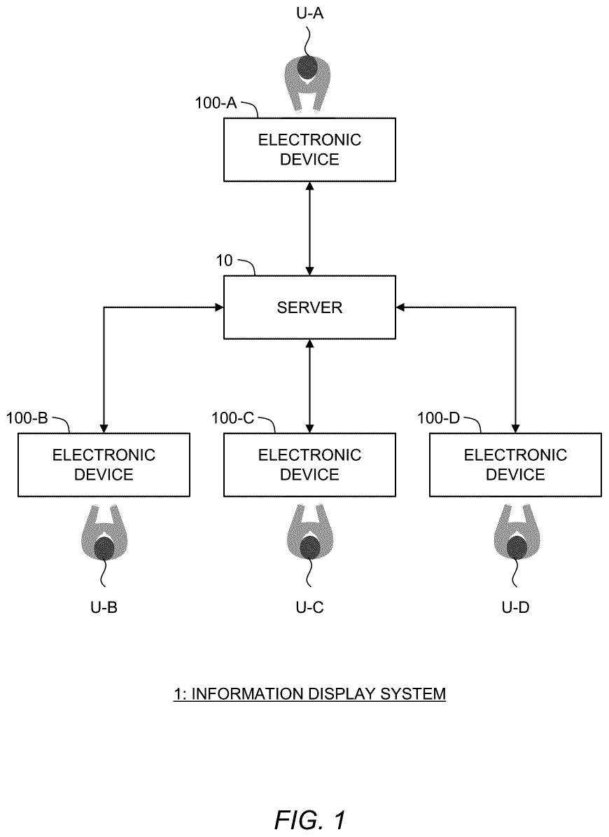

FIG. 1 is a conceptual diagram for explaining an overview of an information display system 1 according to the present embodiment. The information display system 1 includes a plurality of electronic devices 100. Examples of the electronic device 100 include a personal computer, a tablet, and a dedicated terminal. The plurality of electronic devices 100 are used by a plurality of users U, respectively. In the example shown in FIG. 1, the electronic devices 100-A, 100-B, 100-C, and 100-D and respective users U-A, U-B, U-C, and U-D are shown. However, the number of electronic devices 100 and the number of users U are arbitrary.

The plurality of electronic devices 100 are connected to each other via a communication network and can communicate with each other. The communication network may be a wireless communication network or a wired communication network. The plurality of electronic devices 100 may be connected to a server 10 and may communicate with each other through the server 10.

In addition, each of the plurality of electronic devices 100 includes a camera (an imaging device) and a display (display device). The camera is installed so as to be able to capture (take) an image of the user U. Typically, the camera is installed so as to be able to capture the face of the user U.

The electronic device 100-i (i=A, B, C, D . . . ) acquires an image IMG-i of the user U-i captured (taken) by the camera. The image IMG-i includes at least the face of the user U-i. The electronic device 100-i transmits the image IMG-i to another electronic device 100-j (j≠i). The electronic device 100-i may extract a feature parameter of the user U-i based on the image IMG-i and transmit information of the feature parameter of the user U-i to another electronic device 100-j. Examples of the feature parameter include line-of-sight information, a gaze point, an expression parameter, a posture parameter, and the like of the user U-i. Typically, the electronic device 100-i transmits at least one of the image IMG-i and the feature parameter to another electronic device 100-j in real time.

The electronic device 100-j receives the information transmitted from the electronic device 100-i. The electronic device 100-j acquires a user image UIMG-i representing the user U-i based on at least one of the image IMG-i and the feature parameter. The user image UIMG-i may be an original image IMG-i or may be an avatar image. The avatar image is generated by applying at least one of the original image IMG-i and the feature parameter to a predetermined person model, for example. The electronic device 100-j displays the user image UIMG-i representing the user U-i on the display. The user U-j of the electronic device 100-j can see the user image UIMG-i displayed on the display. That is, the electronic device 100-j displays the user image UIMG-i representing the user U-i of another electronic device 100-i being the communication partner, and the user U-j can see the user image UIMG-i representing another user U-i being the communication partner.

The information display system 1 according to the present embodiment is applicable to, for example, online learning, online class, online meeting, and the like. In these examples, the information display system 1 may be referred to as an online learning system, an online lesson system, an online meeting system, or the like.

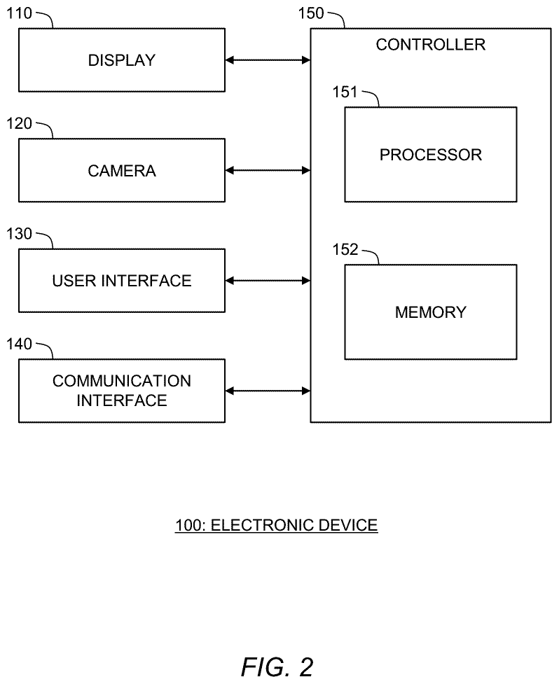

2. Configuration Example of Electronic Device FIG. 2 is a block diagram showing a configuration example of the electronic device 100. In the example shown in FIG. 2, the electronic device 100 includes a display 110, one or more cameras 120 (hereinafter simply referred to as a camera 120), a user interface 130, a communication interface 140, and a controller 150.

The display 110 is configured to display a variety of information. Examples of the display 110 include a liquid crystal display, an organic EL display, a head-up display (HUD), and the like. The display 110 includes a display surface (display unit) 111. Typically, the user U of the electronic device 100 uses the electronic device 100 while facing the display surface 111 of the display 110.

The camera 120 is installed so as to be able to capture an image of the user U of the electronic device 100. Typically, the camera 120 is installed so as to be able to capture an image of the face of the user U of the electronic device 100. For example, the camera 120 is provided around the display surface 111 of the display 110.

The user interface 130 includes an input device that receives input of a variety of information from the user U. Examples of the input device include a touch panel, a keyboard, a mouse, a microphone, and the like. The user interface 130 may include an output device such as a speaker and the like.

The communication interface 140 is connected to a communication network and communicates with the outside of the electronic device 100. The communication network may be a wireless communication network or a wired communication network. For example, the communication interface 140 communicates with the server 10 or another electronic device 100.

The controller 150 executes a variety of information processing. The controller 150 may also be referred to as processing circuitry. The processing circuitry is hardware programmed to perform functions or hardware configured to perform functions.

For example, the controller 150 includes one or more processors 151 (hereinafter simply referred to as a processor 151) and one or more memories 152 (hereinafter simply referred to as a memory 152). The processor 151 executes a variety of information processing. Examples of the processor 151 include a general-purpose processor, a special-purpose processor, a central processing unit (CPU), a graphics processing unit (GPU), an application specific integrated circuit (ASIC), a field-programmable gate array (FPGA), an integrated circuit, a conventional circuit, and/or combinations thereof. The memory 152 stores a variety of information. Examples of the memory 152 include a volatile memory, a nonvolatile memory, a hard disk drive (HDD), a solid state drive (SSD), and the like. A control program is a computer program executed by the processor 151. The function of the controller 150 may be realized by a cooperation between the processor 151 executing the control program and the memory 152. The control program is stored in the memory 152. Alternatively, the control program may be recorded on a non-transitory computer-readable recording medium.

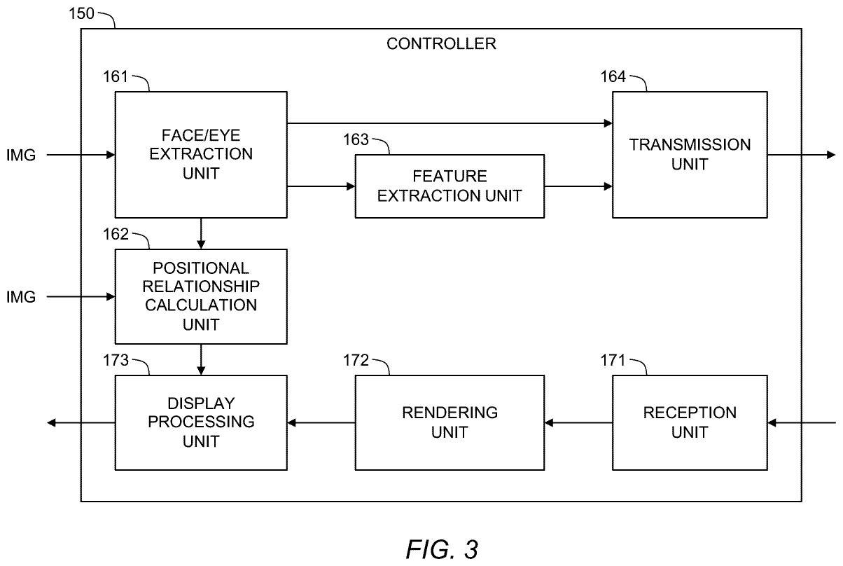

FIG. 3 is a block diagram showing an example of a functional configuration of the controller 150. In the example shown in FIG. 3, the controller 150 includes, as functional blocks, a face/eye extraction unit 161, a positional relationship calculation unit 162, a feature extraction unit 163, a transmission unit 164, a reception unit 171, a rendering unit 172, and a display processing unit 173.

The face/eye extraction unit 161 acquires the image IMG of the user U captured by the camera 120. The image IMG includes at least the face of the user U. Typically, the face/eye extraction unit 161 acquires the image IMG in real time. Then, the face/eye extraction unit 161 extracts a face image of a face portion of the user U from the image IMG. Further, the face/eye extraction unit 161 may extract images of left and right eyes of the user U from the image IMG or the face image. The extraction of the face image and the eye image is performed by the use of a machine learning model generated in advance through machine learning, for example.

The positional relationship calculation unit 162 calculates a relative positional relationship between the left and right eyes of the user U and the display surface 111 (display unit) of the display 110. More specifically, the positional relationship calculation unit 162 acquires the image IMG of the user U captured by the camera 120. The positional relationship calculation unit 162 grasps a position and a size of the face and positions of the left and right eyes of the user U in the image IMG based on the result of extraction by the face/eye extraction unit 161. An installation position, an installation direction, and an angle of view of the camera 120 are known information. It is assumed that a size of a face of a general user U is also known information. The positional relationship calculation unit 162 calculates (estimates) a relative positional relationship between the camera 120 and the left and right eyes of the user U based on the above-described known information and the position and the size of the face of the user U and the positions of the left and right eyes in the image IMG. As another example, a distance between the camera 120 and the user U may be calculated based on the blur state of the image IMG. A relative positional relationship between the camera 120 and the display surface 111 of the display 110 is also known information. The positional relationship calculation unit 162 calculates the relative positional relationship between the left and right eyes of the user U and the display surface 111 by combining the relative positional relationship between the camera 120 and the left and right eyes of the user U and the relative positional relationship between the camera 120 and the display surface 111 of the display 110.

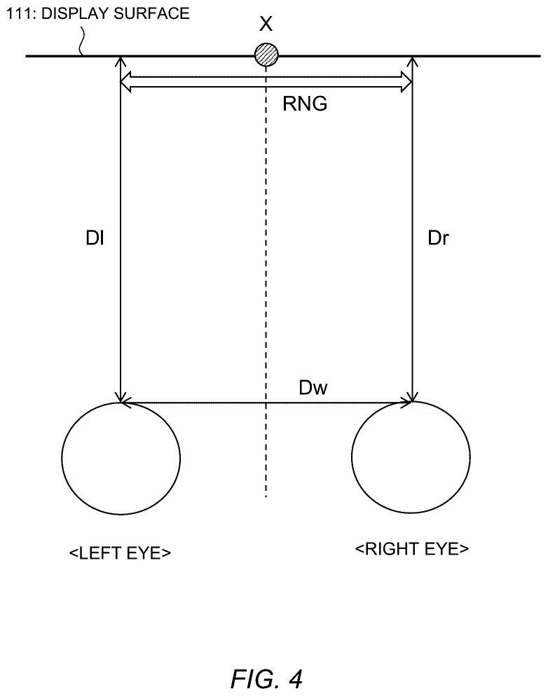

FIG. 4 is a conceptual diagram showing the relative positional relationship between the left and right eyes of the user U and the display surface 111 of the display 110. The relative positional relationship includes at least a distance D1 between the left eye and the display surface 111 and a distance Dr between the right eye and the display surface 111. The relative positional relationship may include a distance Dw between the left eye and the right eye.

The feature extraction unit 163 extracts a feature parameter of the user U. Examples of the feature parameter include line-of-sight information, a gaze point, a facial expression parameter, a posture parameter, and the like of the user U. The feature extraction unit 163 extracts the feature parameter of the user U based on the images of the left and right eyes and the face image of the user U.

For example, the feature extraction unit 163 recognizes a position and a rotation angle of pupil (iris) of each eye based on the images of the left and right eyes of the user U. Then, the feature extraction unit 163 recognizes a gaze direction of each eye based on the position and the rotation angle of the pupil of each eye. The line-of-sight information includes the gaze direction of each eye. The feature extraction unit 163 may calculate coordinate information of a point at which the line of sight and the display surface 111 intersect each other, in consideration of the coordinate system on the display surface 111. The coordinate information of the point at which the line of sight and the display surface 111 intersect may be given as the line-of-sight information of the user U.

The feature extraction unit 163 may calculate a point at which the line of sight of the left eye and the line of sight of the right eye of the user U intersect. The point at which the line of sight of the left eye and the line of sight of the right eye intersect is also referred to as a focal point. When the pupil is shifted inward, the focal point becomes closer. On the other hand, when the pupil is shifted outward, the focal point becomes farther. The focal point corresponds to the “gaze point” at which the user U gazes. It should be noted that not only real-time information of the gaze point but also statistical information of the gaze point within a certain period of time may be used.

The feature extraction unit 163 may extract the facial expression parameter representing facial expression of the user U based on the face image of the user U. The extraction of the facial expression parameter is performed by the use of a machine learning model generated in advance through machine learning, for example.

The feature extraction unit 163 may extract the posture parameter indicating a posture (the angle of the face or the like) of the user U based on the face image of the user U or the image IMG. The extraction of the posture parameter is performed by the use of a machine learning model generated in advance through machine learning, for example.

The transmission unit 164 transmits information on the user U to another electronic device 100 via the communication interface 140. Typically, the transmission unit 164 transmits real-time information on the user U to another electronic device 100. The transmission information includes at least one of the image IMG of the user U, the face image, and at least a part of the feature parameters.

The reception unit 171 receives information of another user U (referred to as a user U-i for convenience) from another electronic device 100 via the communication interface 140. The received information includes at least one of the image IMG-i, the face image, and at least a part of the feature parameters of the user U-i.

The rendering unit 172 acquires the received information from the reception unit 171. The rendering unit 172 performs rendering processing based on the received information to acquire a user image UIMG-i representing the user U-i. For example, the user image UIMG-i is an avatar image. A predetermined three dimensional person model is prepared in advance. The rendering unit 172 performs the rendering processing by applying the face image or the feature parameters (facial expression and posture) of the user U-i to the predetermined three dimensional person model, thereby acquiring the avatar image representing the user U-i.

The display processing unit 173 displays the user image UIMG-i representing the user U-i on the display 110 (the display surface 111). The user U of the electronic device 100 can see the displayed user image UIMG-i.

The display processing unit 173 may display the user image UIMG-i on the display 110 (the display surface 111) such that the user U-i appears to float off the display surface 111. This process is hereinafter referred to as a “3D (three dimensional) display process” or a “stereoscopic display process”. The display processing unit 173 executes the 3D display process as necessary. More specifically, the display processing unit 173 acquires information on the relative positional relationship between the left and right eyes of the user U and the display surface 111 from the above-described positional relationship calculation unit 162. Then, the display processing unit 173 executes the 3D display process based on the relative positional relationship between the left and right eyes of the user U and the display surface 111.

For example, in FIG. 4, a position X on the display surface 111 is a position corresponding to an intermediate position between the left and right eyes of the user U. A range RNG on the display surface 111 is a range corresponding to a space between the left and right eyes of the user U and includes the position X. The display processing unit 173 is able to recognize the position X and the range RNG based on the relative positional relationship between the left and right eyes of the user U and the display surface 111. Then, the display processing unit 173 displays the user image UIMG-i on the display surface 111 so as to be within the range RNG. That is, the display processing unit 173 displays the user image UIMG-i between the left and right eyes of the user U. Thus, the user U-i appears to float off the display surface 111 when viewed from the user U.

It should be noted that the 3D display process may be implemented by another method. For example, the 3D display process may be realized by a lenticular method using a lenticular lens. In the case of the lenticular method, a target image for the left eye and a target image for the right eye are separately prepared and separately displayed on the display surface 111 such that the target appears to float off the display surface 111.

### 3. 3D Display Process in Fixed Mode

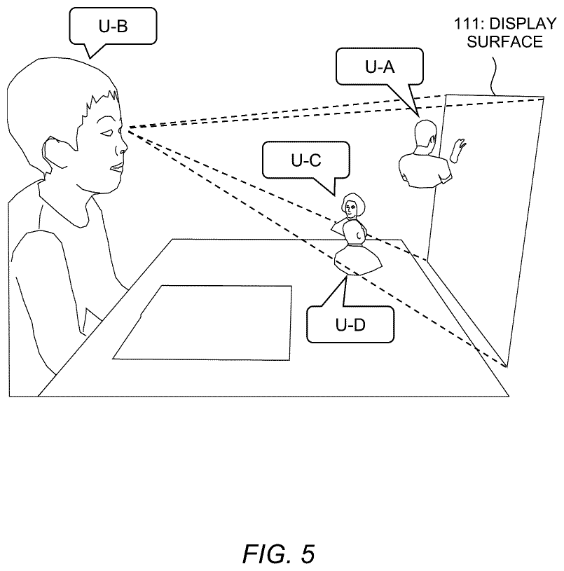

FIG. 5 conceptually shows an example of the 3D display process in the electronic device 100-B used by the user U-B. The 3D display process is executed such that a plurality of other users U-A, U-C, and U-D other than the user U-B appear to float off the display surface 111. Typically, the 3D display process is executed such that apparent positions of the users U-A, U-C, and U-D are present on lines connecting between the left and right eyes of the user U-B and the display surface 111.

Here, a “fixed mode” being one of modes of the 3D display process is considered. In the fixed mode, a specific one of the plurality of users U is set as a “fixed user”. The fixed user may be automatically set by the information display system 1 or may be designated by any one of the users U. In the following description, a case where the user U-A is set as the fixed user will be considered.

FIG. 5 also conceptually illustrates the “apparent positions” of the users U-A, U-C, and U-D in the fixed mode. As shown in FIG. 5, when viewed from the user U-B, the user U-A who is the fixed user appears to be closest to the display surface 111, and the other users U-C and U-D appear to be in front of the user U-A. In other words, when viewed from the user U-B, the apparent position of the user U-A who is the fixed user is closest to the display surface 111, and the apparent position of the other users U-C and U-D are farther from the display surface 111 than the user U-A is. Since the positional relationship between the user U-A being the fixed user and the other users U-C and U-D is expressed, the sense of strangeness in appearance in the 3D displaying of the plurality of users U is reduced.

For example, the information display system 1 is an online lesson system, the user U-A is a teacher, and the other users U-B, U-C, and U-D are students. In this case, the user U-A who is a teacher is set as the fixed user. When viewed from the user U-B who is a student, the teacher appears to be closest to the display surface 111, and the other students appear to be in front of the teacher. This is in line with the actual lesson landscape. Therefore, the sense of strangeness in appearance in the 3D displaying of the plurality of users U is reduced.

The following is a generalized description. A first user U-1 is a user of a first electronic device 100-1. A first user image UIMG-1 is an image representing the first user U-1. A second user U-2 is a user of a second electronic device 100-2. A second user image UIMG-2 is an image representing the second user U-2. A third user U-3 is a user of a third electronic device 100-3. The controller 150 of the third electronic device 100-3 acquires the first user image UIMG-1 and the second user image UIMG-2. The controller 150 of the third electronic device 100-3 executes the 3D display process that displays the first user image UIMG-1 and the second user image UIMG-2 on the display 110 (the display surface 111) such that the first user U-1 and the second user U-2 appear to float off the display surface 111.

The controller 150 of the third electronic device 100-3 uses the camera 120 to acquire an image IMG of the third user U-3. The controller 150 of the third electronic device 100-3 calculates the relative positional relationship between the left and right eyes of the third user U-3 and the display surface 111 based on the image IMG of the third user U-3. The controller 150 of the third electronic device 100-3 may execute the 3D display process based on the relative positional relationship between the left and right eyes of the third user U-3 and the display surface 111. The controller 150 of the third electronic device 100-3 may execute the 3D display process such that the apparent position of the first user U-1 and the apparent position of the second user U-2 are present on lines connecting between the left and right eyes of the third user U-3 and the display surface 111.

In the fixed mode in which the first user U-1 is fixed as the fixed user, the controller 150 of the third electronic device 100-3 executes the 3D display process such that the first user U-1 appears to be closest to the display surface 111 and the second user U-2 appears to be in front of the first user U-1. In other words, the controller 150 of the third electronic device 100-3 executes the 3D display process such that the apparent position of the first user U-1 is closest to the display surface 111 and the apparent position of the second user U-2 is farther from the display surface 111 than the first user U-1 is. As a result, the positional relationship between the first user U-1 (i.e., the fixed user) and the other second user U-2 is expressed, and therefore, the sense of strangeness in appearance in the 3D displaying of the plurality of users U is reduced.

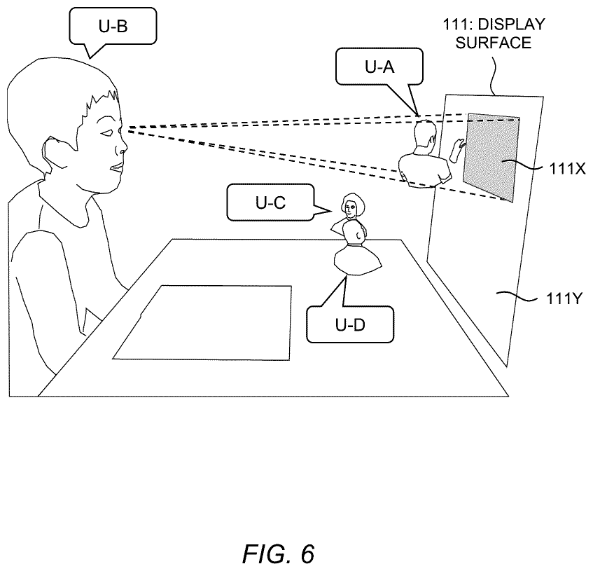

FIG. 6 is a conceptual diagram for explaining another example of the 3D display process in the fixed mode. In the example shown in FIG. 6, specific information is displayed in a first region 111X of the display surface 111.

The specific information is, for example, information generated or input by the user U-A who is the fixed user. For example, the specific information is a description (written on a board) written by the user U-A who is a teacher. For example, the user U-A writes an explanation on a predetermined object, and the explanation is captured by the camera 120 of the electronic device 100-A. As another example, the user U-A may input an explanation using the user interface 130 of the electronic device 100-A. The specific information is the captured image of the description or the input information of the description. The specific information is transmitted to the other electronic devices 100-B, 100-C, and 100-D. Each of the electronic devices 100-B, 100-C, and 100-D displays the specific information in the first region 111X of the display surface 111 of the display 110.

If the first region 111X is hidden by the users U-C and U-D who appear to float off the display surface 111, the user U-B cannot see the specific information displayed in the first region 111X. Therefore, the display positions of the users U-C and U-D are adjusted. More specifically, a second region 111X other than the first region 111Y of the display surface 111 is considered. No specific information is displayed in the second region 111Y. When the specific information is displayed in the first region 111X, the 3D display process is executed such that the apparent positions of the users U-C and U-D are present on lines connecting between the second region 111Y and the left and right eyes of the user U-B. As a result, the user U-B is able to see the specific information displayed in the first region 111X.

The following is a generalized description. In the fixed mode, when the specific information is displayed in the first region 111X of the display surface 111, the controller 150 of the third electronic device 100-3 executes the 3D display process such that the apparent position of the second user U-2 is present on lines connecting between the second region 111Y and the left and right eyes of the third user U-3. As a result, the third user U-3 is able to see the specific information displayed in the first region 111X.

### 4. Mode Switching

The modes of the 3D display process may include the “fixed mode” in which the fixed user is set and a “free mode” in which no fixed user is set. The fixed mode and the free mode can be switched. The user U may select (designate) one of the fixed mode and the free mode by the use of the user interface 130. The controller 150 receives information of a mode selected (designated) by the user U via the user interface 130. Then, the controller 150 executes the 3D display process in the mode selected (designated) by the user U.

What is claimed is:

1. An electronic device for displaying information, comprising:
a display having a display surface; and
processing circuitry, wherein
a first user image is an image representing a first user who is a user of a first electronic device communicating with the electronic device,
a second user image is an image representing a second user who is a user of a second electronic device communicating with the electronic device, and
the processing circuitry is configured to:
acquire the first user image and the second user image;
execute a 3D display process that displays the first user image and the second user image on the display such that the first user and the second user appear to float off the display surface; and
in a fixed mode in which the first user is set as a fixed user, execute the 3D display process such that the first user appears to be closest to the display surface and the second user appears to be in front of the first user.

2. The electronic device according to claim 1, further comprising a camera, wherein
the processing circuitry is further configured to:
acquire an image of a third user who is a user of the electronic device, the image being captured by the camera;
calculate a positional relationship between left and right eyes of the third user and the display surface based on the image of the third user; and
execute the 3D display process based on the positional relationship between the left and right eyes of the third user and the display surface.

3. The electronic device according to claim 2, wherein
in the fixed mode, the processing circuitry is further configured to execute the 3D display process such that an apparent position of the first user and and an apparent position of the second user are present on lines connecting between the left and right eyes of the third user and the display surface.

4. The electronic device according to claim 2, wherein
in the fixed mode and when specific information is displayed in a first region of the display surface, the processing circuitry is further configured to execute the 3D display process such that an apparent position of the second user is present on lines connecting between a second region other than the first region of the display surface and the left and right eyes of the third user.

5. An information display system comprising:
a plurality of electronic devices connected to each other via a communication network, wherein
each of the plurality of electronic devices comprises:
a display having a display surface; and
processing circuitry,
a first user image is an image representing a first user who is a user of a first electronic device among the plurality of electronic devices,
a second user image is an image representing a second user who is a user of a second electronic device among the plurality of electronic devices, and
the processing circuitry of a third electronic device among the plurality of electronic devices is configured to:
acquire the first user image and the second user image;
execute a 3D display process that displays the first user image and the second user image on the display such that the first user and the second user appear to float off the display surface; and
in a fixed mode in which the first user is set as a fixed user, execute the 3D display process such that the first user appears to be closest to the display surface and the second user appears to be in front of the first user.
